(19) United States
(12) Patent Application Publication
(10) Pub. No.: US 2006/0138255 A1
(43) Pub. Date: Jun. 29, 2006

(54) Injector

(75) Inventors: Akira Nakatsu, Nagoya-city (JP); Senta Tojo, Nagoya-city (JP); Masayoshi Ito, Hoi-gun (JP); Mitsuru Ueki, Kariya-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/314,367

(22) Filed: Dec. 22, 2005

(30) Foreign Application Priority Data
Dec. 24, 2004 (JP) 2004-374757

(51) Int. Cl. F02M 63/00

(52) U.S. Cl. 239/533.2

(57) ABSTRACT

A tip end surface of a valve body and a back end surface of an injection nozzle contact each other with pressure by being fastened using a retaining nut and thereby form a metal seal structure to achieve a metal seal. To increase a surface pressure in a seal surface by fastening axial force, conventional recesses around the central axis of a nozzle are replaced so that proximity of a high pressure fuel hole is secured as a seal surface. An outside recess is provided outside of the proximity of the high pressure fuel hole to link with an outer peripheral border of the metal seal structure. Alternatively, a contact surface functioning as a retaining seal surface is added outside of the outside recess to be apart from the proximity of the high pressure fuel hole.

### CROSS REFERENCE TO RELATED APPLICATIONS

This application is based on and incorporates herein by reference Japanese Patent Application No. 2004-374757 filed on Dec. 24, 2004.

### FIELD OF THE INVENTION

The present invention relates to an injector (fuel injection valve) for injecting high pressure fuel accumulated inside a common rail, to a combustion chamber of an internal-combustion engine, by pressurizing using a high pressure feed pomp.

### BACKGROUND OF THE INVENTION

An injector is used in an accumulator type fuel injection apparatus such as a diesel engine and injects high pressure fuel fed from a common rail to a combustion chamber of an engine. This injector includes an injection valve body having near its tip end an injection nozzle, and a driving means such as an electromagnetic valve arranged near the back end of the injection valve body. The driving means such as an electromagnetic valve receives control signals from an engine control unit (ECU), displaces a control piston contained in the injection valve body and a needle contained in the injection nozzle, and thereby opens and closes a fuel injection hole of the injection nozzle. This opening/closing control adjusts an amount, timing, or the like of injection fuel injected from the injection nozzle based on operating conditions of the engine.

The injection valve main body has a rod shape and includes a cylinder that penetrates the road axis and a valve body that has a high pressure fuel flow path and a low pressure fuel flow path. The tip end of the valve body is coaxially connected to the injection nozzle and fastened by a retaining nut, thereby forming the injection valve main body. The driving means such as an electromagnetic valve is arranged backward of the valve body. The tip end surface of the valve body and the back end surface of the injection nozzle contact with pressure each other so as to form a metal seal structure to seal high pressure fuel flowing through the high pressure fuel flow path. This dispenses with a different material such as a seal ring, being effective as a means for sealing the high pressure fuel in a low cost.

A conventional injector is metal sealed formed by connecting with pressure the tip end surface 2A of the valve body 20 and the back end surface 4A of the injection nozzle 4 therebetween, as shown in FIGS. 1A, 1B, 6. The back end surface 4A of the injection nozzle 4 has recesses 6 formed by counterboring processing or the like around the central cylinder 21 so as to maintain a seal pressure by fastening axial force of the retaining nut 25. Forming the recesses 6 decreases an actual contact area and increases surface pressure so as to secure seal property of the high pressure fuel. Therefore, the recesses 6 (e.g., arrangement, sizes, numbers of the recesses) have a key point to effectively transform limited fastening axial force to a large surface pressure and thereby secure the sufficient seal. Here, no prior art document is referred to.

Recent demand in more accurate control of the fuel injection and finer atomization of the fuel increases a pressure of the high pressure fuel to 200 MPA or more, thereby causing the high pressure fuel to leak outside of the injector. A conventional surface (back end surface 4A) of the injection nozzle 4 includes a needle cylinder 45, a high pressure fuel hole 46A, and a low pressure fuel hole 47A. Both holes 46A, 47A approximately face each other with respect to a center of the needle cylinder 45. The both holes 46A, 47A are symmetrically arranged with not too short but not too long distance therebetween to secure an proper seal area.

Furthermore, a positioning hole 91 and a positioning pin 92 is arranged as a pair with a sufficient interval therebetween along a line approximately perpendicular to a line linking together the high pressure fuel hole 46A and the low pressure fuel hole 47A with a small offset from the center of the needle cylinder 45. This functions as a foolproof method to prevent mis-assembling when connecting the injection nozzle 4 and the valve body 20. Thus, the high pressure fuel hole 46A, the low pressure fuel hole 47A, the positioning hole 91, and the positioning pin 92 are arranged in four directions with approximately equal interval distances therebetween to constitute a seal structure (or back end surface 4A).

Furthermore, each of the recesses 6 is arranged approximately at an intermediate position (being displaced with approximately 45 degrees to the adjacent recess with respect to the axis) of positions of two of the high pressure fuel hole 46A, the low pressure fuel hole 47A, the positioning hole 91, and the positioning pin 92, which are arranged in the four directions with the approximately equal interval distances. Each of the recesses 6 has a semi-elliptic shape. One longitudinal end reaches a middle position without reaching an outer peripheral border, while the other longitudinal end is linked with the needle cylinder 45. The lateral end is not connected with a lateral end of an adjacent recess, so the four recesses 6 are arranged with approximately equal interval distances around the needle cylinder 45. The recesses 6 are concaved portions such as counterboring with slight steps from the seal surface (back end surface 4A). This structure decreases an area for facing a mutual adjacent surface to obtain a preferred surface pressure.

Here, the conventional surface (or back end surface 4A) has recesses 6 to be located as flower petals from the center of the cylinder towards a circumference formed along the centers of the high pressure fuel hole 46A, the low pressure fuel hole 47A, the positioning hole 91, and the positioning pin 92. This increases a surface pressure near the center of the needle cylinder 45 compared with a surface pressure in an outside peripheral portion. The surface pressure in the outside peripheral portion cannot sometimes sufficiently maintain a seal property against the increased fuel pressure. Furthermore, even if the surface pressure is increased to increase an axial force by further fastening the retaining nut, only a portion near the central portion where the recesses 6 are located are increased in its surface pressure. The outside peripheral portion can obtain less effect. Thus, the conventional recesses 6 cannot sufficiently obtain the surface pressure in the outside peripheral portion. Furthermore, although increase in the surface pressure in the outside peripheral portion is expected to achieve leak prevention in the outside peripheral portion, increase of the surface pressure by increasing the axial force does not effectively act on increase in the surface pressure in the outside peripheral portion. This causes dissatisfactions. These take place not frequently with respect to the high pressure fuel of not more than 150 MPA. However, increasing the pressure to 200 MPA or more poses a problem that the high pressure fuel leaks outward from the high pressure fuel hole 46A

### SUMMARY OF THE INVENTION

It is an object of the present invention to provide an injector for securing a seal for high pressure fuel by effectively providing a high seal surface pressure, especially in a proximity surrounding a high pressure fuel hole 46A.

To achieve the above object, an injector is provided with the following. The injector comprises an injection valve main body whose tip end is linked with an injection nozzle, and a driving means arranged backward of the injection valve main body. The injection valve main body includes a valve body. The valve body includes in its central portion a cylinder, and further includes a high pressure fuel flow path and a low pressure fuel flow path, both of which are parallel with the cylinder. The injection nozzle is linked with the valve body and includes a needle valve linked with the cylinder, a high pressure fuel hole linked with the high pressure fuel flow path, and a low pressure fuel hole linked with the low pressure fuel flow path. A back end surface of the injection nozzle and a tip end surface of the valve body contact each other with pressure to form a metal seal structure to achieve a metal seal. A recess is provided in the metal seal structure to increase a seal surface pressure. The injector is characterized in that an outside recess is provided outside of a metal seal in surrounding of a linkage portion between the high pressure fuel flow path and the high pressure fuel hole.

Under this structure, providing the recess outside of surrounding (or proximity) of the high pressure fuel hole decreases a seal area of a high pressure seal surface in the surrounding of the high pressure fuel hole and thereby increases a surface pressure. Furthermore, a surface pressure distribution in an outward leakage direction is caused to be higher than that in an inward direction to the center from the high pressure fuel hole, preventing the outward leakage.

As another aspect of the above injector, a featured structure is adopted so that the outside recess links with an outer peripheral border of the metal seal structure.

Under this structure, the seal surface pressure in the surrounding of the high pressure fuel hole can be designed by a seal area. The necessary and sufficient surface pressure can be secured by the seal area of the necessity minimum meeting the fastening axial force, simply and effectively enhancing the seal property. The outward leakage is thereby prevented.

Furthermore, as yet another aspect of the above injector, a featured structure is further adopted so that a contact surface is provided outside of the outside recess to be apart from a contact surface being the metal seal in the surrounding of the high pressure fuel hole.

Under this structure, the contact surface functions as a retaining surface in addition to the metal seal surface and secures high rigidity to deformation or displacement, and the high seal property. Furthermore, forming the strong seal surface to deformation or displacement enables the high seal property in the surrounding of the high pressure fuel hole to be easily secured by extremely decreasing the seal area of the contact surface in the surrounding of the high pressure fuel hole. The outward leakage can be thereby prevented.

### BRIEF DESCRIPTION OF THE DRAWINGS

The above and other objects, features, and advantages of the present invention will become more apparent from the following detailed description made with reference to the accompanying drawings. In the drawings:

FIG. 1A is a sectional view of a fuel injection valve;

FIG. 1B is an enlarged sectional view of a seal main part;

FIG. 2 is a plan view of a metal seal structure of an injection nozzle (Embodiment 1);

FIG. 3 is a plan view of a metal seal structure of an injection nozzle (Embodiment 2);

FIG. 4 is a plan view of a metal seal structure of an injection nozzle (Embodiment 3);

FIGS. 5A and 5B are plan views of metal seal structures of injection nozzles (another Embodiment); and

FIG. 6 is a plan view of a metal seal structure of an injection nozzle (Related Art).

### DETAILED DESCRIPTION OF THE PREFERRED EMBODIMENTS

### Embodiment 1

### Structure of Embodiment 1

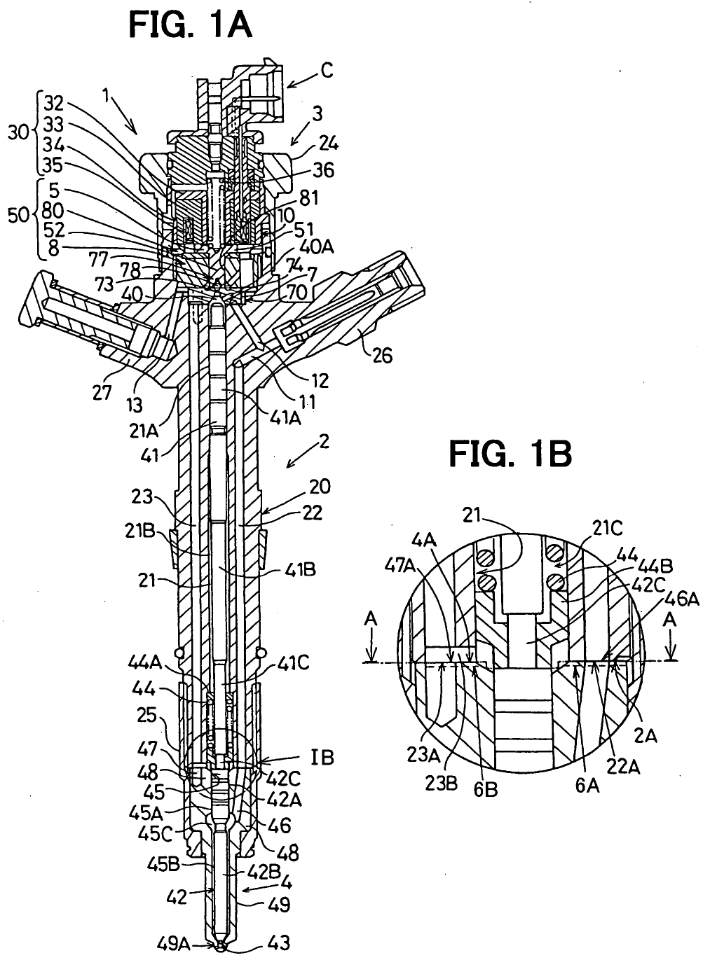

FIG. 1A shows a fuel injection valve 1 of an electromagnetic control type for intermittently injecting fuel into a fuel combustion chamber of an engine, whereas FIG. 1B shows a metal seal structure of a main portion of the fuel injection valve 1.

The fuel injection valve 1 is used for an accumulator type (common rail type) fuel injection apparatus for a diesel engine and injects high pressure fuel fed from a common rail (not shown) to a combustion chamber of the engine.

The fuel injection valve 1 includes an injection valve main body 2, an electromagnetic valve 3 (corresponding to a driving means and including a piezoelectric type) attached to an upper end portion of the injection valve main body 2, and an injection nozzle 4 fastened to a lower end of the injection valve main body 2. The electromagnetic valve 3 includes a connector C connected to a wire harness from an engine control unit (ECU) (not shown) and is controlled by control signals sent from the ECU.

The injection valve main body 2 has a rod shape and includes a cylinder 21 that penetrates the road axis, and a valve body 20 that has a high pressure fuel flow path 22 and a low pressure fuel flow path 23. A tubelike electromagnetic valve installation chamber 10 is arranged in the upper end portion of the valve body 20. The electromagnetic valve 3 is attached to the electromagnetic valve installation chamber 10 and is screwed by a retaining nut 24. A lower end of the valve body 20 is coaxially connected to an injection nozzle 4 and fastened by a retaining nut 25. A cylindrical inlet portion 26 and a cylindrical outlet portion 27 are arranged obliquely upward of the valve body 20.

The electromagnetic valve 3 includes an electromagnetic solenoid 30 that is arranged upward of the electromagnetic valve installation chamber 10 and an opening/closing valve mechanism 50 that is arranged downward of the electromagnetic valve installation chamber 10. The opening/closing valve mechanism 50 includes a movable element 5 and a movable element holder 8 holding the movable element 5.

A slightly small diameter plate chamber 70 is located downward of the movable element holder 8 (or a lower end portion of the electromagnetic valve installation chamber 10) to contain a disk-shaped orifice plate 7.

The electromagnetic solenoid 30 has the following structure: a magnetic core 33 formed of laminated silicon steel surrounds an outer periphery of a ferromagnetic upper-end-flanged tube 32; a ferromagnetic outer tube 34 surrounds an outer periphery of the magnetic core 33; and an electromagnetic coil 35 is arranged within the magnetic core 33. A lower surface of the electromagnetic solenoid 30 forms a suction surface of the movable element 5. A lower end surface of the tube 32 forms a stopper that the movable element 5 collides with.

The inlet portion 26 contains a high pressure fuel inflow path 11 fluidly communicating to the high pressure fuel flow path 22, and an inlet flow path 12 fluidly communicating to the high pressure fuel inflow path 11 and the plate chamber 70. The outlet portion 27 contains an outflow path 13 fluidly communicating to the low pressure fuel flow path 23 via the plate chamber 70, forming an exhaust flow path for exhausting surplus fuel within the fuel injection valve 1 to an outside.

A lower surface of the orifice plate 7 has a recess shaped of a circular cone to form a pressure control chamber 40. An outlet orifice 73 is formed in an upper portion of the center of the pressure control chamber 40. A slant communication hole 40A is open on a slant surface of the circular cone of the pressure control chamber 40 to fluidly communicate with the inlet flow path 12 of the inlet portion 26 in its lower portion via an inlet orifice 74. A fuel pressure of the high pressure fuel fed from the common rail is introduced to the pressure control chamber 40 via the high pressure fuel inflow path 11, the inlet flow path 12, and the inlet orifice 74.

The movable element 5 includes a plate portion 51 and a shaft portion 52. The plate portion 51 is in a movable chamber 80. The movable element holder 8 is tubelike, and the shaft portion 52 is slidably inserted into a central hole of the movable element holder 8. The upper surface of the plate portion 51 is planar and forms a suction surface that is sucked to a lower surface of the electromagnetic solenoid 30. The movable holder 8 is screwed to an inner periphery of the electromagnetic valve installation chamber 10.

The shaft portion 52 is cylindrical, and a valve body chamber 77 having a tube portion and a circular cone portion is provided in the center of the lower end surface. The valve body chamber 77 contains a ball valve 78 made of silicon nitride. The ball valve 78 is spherical in the upper surface and planar in the lower surface for sealing the outlet orifice 73 of the upper surface of the orifice plate 7. The movable element 5 is biased downward (valve closing direction) by a spring 36 provided within the upper-end-flanged tube 32, and is sucked upward (valve opening direction) by magnetic force generated by the electromagnetic solenoid 30, thus moving upward and downward.

The electromagnetic solenoid 30 including the movable chamber 80 and the upper-end-flanged tube 32, and the electromagnetic valve installation chamber 10 containing the opening/closing valve mechanism 50 fluidly communicate with the outflow path 13 linked with the low pressure fuel flow path 23, thereby being filled with the low pressure fuel oil. Consequently, with respect to vertical movement of the movable element 5, resistance of the low pressure fuel oil occurs in the plate portion 51, which affects responsiveness of the electromagnetic valve 3. Furthermore, vertical movement of the movable element 5 is accompanied by impact, so the movable element 5 is a key component in view of endurance. A proper shape of the movable element 5 is adopted in consideration of this fact.

The cylinder 21 penetrates the center of the valve body 20. The cylinder 21 includes a sliding portion 21A that has a slightly smaller diameter, a pressure receiving portion 21B, and a spring receiving portion 21C, and contains a control piston 41. The control piston 41 corresponds to the structure of the cylinder 21, and is a tubelike vertical movement piston to include a sliding portion 41A, a pressure receiving portion 41B, and a spring portion 41C. The upper end of the control piston 41 has a circular truncated cone and is arranged with a proper interval (space) with the pressure control chamber 40 formed in the orifice plate 7. The control piston 41 is pushed downward based on pressure of the pressure control chamber 40 and moves with the sliding portion 41A being slided. In contrast, the lower end of the control piston 41 contacts, in its flat surface, the upper end portion of the needle valve 42 contained within the injection nozzle 4.

Furthermore, the valve body 20 includes, separately from and parallel with the cylinder 21, a high pressure fuel flow path 22 that fluidly communicates to the high pressure fuel inflow path 11 of the inlet portion 26 and opens in the lower end surface of the valve body 20 to form a high pressure fuel hole 22A.

Furthermore, the valve body 20 includes a low pressure fuel flow path 23, which fluidly communicates to the outflow path 13 of the outlet portion 27, in the opposing side of the high pressure fuel flow path 22 separately from and parallel with the cylinder 21 and opens in the lower end surface of the valve body 20 to form a low pressure fuel hole 23A. The low pressure fuel hole 23A further includes a low pressure fuel communication groove 23B that advances to the center of the cylinder 21 to communicates with an inside of the cylinder 21.

Furthermore, the valve body 20 including the high pressure fuel hole 22A, the low pressure fuel hole 23A, and the low pressure fuel communication groove 23B has an even lower end surface to form a tip end surface 2A and contacts a back end surface 4A of the injection nozzle 4 to thereby form a metal seal structure.

A spring 44 along with a spring receiving seat 44A and a bearing receiving seat 44B is inserted into the spring receiving portion 21C of the cylinder 21 opening at the lower end surface of the valve body 20.

The injection nozzle 4 is a two step tube shape including a large diameter nozzle body 48 and a small diameter nozzle 49. A retaining nut 25 is hanged to a step portion and fastened to a screw formed at the lower end outer periphery of the valve body 20 to generate an axial force or a seal pressure. The needle cylinder 45 containing in its center the needle valve 42 includes a sliding portion 45A and a fuel path 45B, which have mutually slightly different inner diameters from each other. A fuel reservoir 45C having a large diameter and a large capacity is arranged upstream of the fuel path 45B to fluidly communicate to the high pressure fuel flow path 46.

Furthermore, a nozzle tip end chamber 49A having an appropriately thin taper structure is arranged downward of the fuel path 45B to close the lower end of the needle cylinder 45. The nozzle tip end chamber 49A properly includes one or multiple injection holes in proper positions to atomize the high pressure fuel.

The other end of the high pressure fuel flow path 46 opens at an upper surface of the injection nozzle 4 to form a high pressure fuel hole 46A. A low pressure fuel flow path 47 is arranged opposite to the needle cylinder 45 of the high pressure fuel hole 46A in the upper portion of the injection nozzle 4, and a low pressure fuel hole 47A opens at an upper surface of the injection nozzle 4.

The low pressure fuel flow path 47 is occluded in a proper depth to dedicatedly function as a low pressure fuel reservoir. The back end surface 4A of the injection nozzle 4 including the high pressure fuel hole 46A and the low pressure fuel hole 47A has an even flat surface and contacts the tip end surface 2A of the valve body 20 to form a metal seal structure.

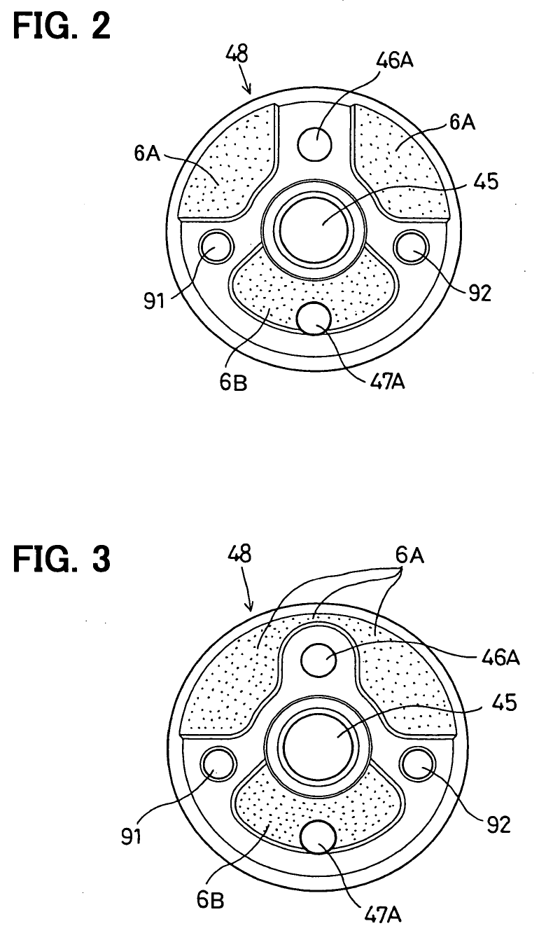

FIG. 2 shows a metal seal structure (back end surface 4A) of Embodiment 1 of the present invention. The high pressure fuel hole 46A, the low pressure fuel hole 47A, the positioning hole 91, and the positioning pin 92 are arranged with approximately equal interval distances to each other in the metal seal structure. Here, this metal seal structure includes recesses 6A, 6B and a metal seal surface. In the metal seal structure, a recess 6B is arranged to have a quarter sector form bi-laterally symmetric by nipping the low pressure fuel hole 47A to have a 90-degree central angle, and further by excluding an outer peripheral border of the low pressure fuel hole 47A. Furthermore, recesses 6A are arranged to have quarter sector forms of 90-degree central angles bilaterally symmetric with respect to the high pressure fuel hole 46A. These recesses 6A link to the outer peripheral border of the nozzle body 48, but do not include proximity of the high pressure fuel hole 46A to thereby leave a seal surface in an interval area with the needle cylinder 45. Here, above all recesses 6A, 6B are formed by counterboring (or spot-facing). Thus, the proximity that surrounds the high pressure fuel hole 46A and reaches the outer peripheral border of the nozzle body 48 constitutes a metal seal surface of the metal seal structure, whereas the adjacent recesses 6A arranged in opposing sides with respect to the high pressure fuel hole 46A at least reach the outer peripheral border of the nozzle body 48.

The seal surface is thus formed as a relatively small area to include a seal surface portion that is centralized at the high pressure fuel hole 46A and radically spread from the needle cylinder 45 up to the outer peripheral border of the nozzle body 48; and a seal surface portion that is centralized at the low pressure fuel hole 47A and includes almost half of the outer peripheral border of the nozzle body 48. In particular, the adjacent recesses 6A arranged in the opposing sides of the high pressure fuel hole 46A to open to the outer peripheral border, so that the axial force is changed to an effective surface pressure in the proximity of the high pressure fuel hole 46A. A good seal property can be thereby achieved.

The needle valve 42 is an almost tubelike shape and consists of a sliding portion 42A slidably holding and a needle portion 42B constituting a pressure receiving step and having a slightly smaller diameter to correspond to the structure of the needle cylinder 45. The tip end of the needle portion 42B has a needle valve structure having a proper circular truncated cone. Its vertical movement closes or opens up the injection hole 43 of the nozzle tip end chamber 49A having a taper structure. Furthermore, a contact protruding portion 42C having a smaller diameter than the sliding portion 42A is attached to a bearing seat 44B, in the upper end of the needle valve 42. A spring 44 is concentrically retained and the needle valve 42 is biased downward of the spring 44 (to a direction where the injection hole 43 is to be closed). Here, the contact protruding portion 42C can be arranged in a lower end of the control piston 41 as long as the contact protruding portion 42C is attached to the bearing seat 44B to concentrically retain the spring 44 and supports the biasing force securely.

The needle valve 42 opens and closes by moving upward and downward by balance of downward and upward biasing forces. The downward biasing force is formed by a spring load of a fuel pressure inside the pressure control chamber 40 and the spring 44. The upward biasing force is applied to the needle valve 42 by the fuel pressure inside the injection nozzle 4. Namely, when the pressure control chamber 40 becomes low pressure, the control piston 41 and the needle valve 42 moves upward and the injection hole 43 opens. High pressure fuel fed to the injection nozzle 4 from the high pressure fuel flow path 22 is injected to the combustion chamber.

### Operation of Embodiment 1

Operation of the fuel injection valve 1 of Embodiment 1 will be explained with reference to FIGS. 1, 2. In this fuel injection valve 1, the movable element 5 moves upward by being sucked by electromagnetic force and an annular contact flat surface stops by colliding with a lower surface (stopper surface) of the tube 32. In conjunction with the movable element 5, the ball valve 78 is displaced upward and the outlet orifice 73 then opens to communicate with the outflow path 13 of the low pressure fuel. The pressure inside of the pressure control chamber 40 thereby instantly becomes low pressure and a pressure balance acting on the control piston 41 inside of the cylinder 21 crumbles, causing the control piston 41 to move upward. In conjunction with this movement, the needle valve 42 of the needle cylinder 45 moves upward due to the pressure of the high pressure fuel in the fuel reservoir 45C and the high pressure fuel from the fuel reservoir 45C is atomized via the opening injection hole 43. At this time instant, the seal surface in the back end surface 4A achieves secured seal and feeds a proper amount of the high pressure fuel to the injection hole 43 without leakage to an outside, which prevents an engine performance from being decreased. When electric power distribution to the electromagnetic solenoid 30 is thereafter cut off, the movable element 5 moves downward due to the biasing force of the spring 36 and the ball valve 78 closes the outlet orifice 73, the pressure of the high pressure fuel acts on the pressure control chamber 40 from the inlet orifice 74, the control piston 41 moves downward, the needle valve 42 simultaneously moves downward to close the injection hole 43, and the injection of the fuel ends.

### Effect of Embodiment 1

This embodiment is provided with an injection valve body 2 linked in its tip end to an injection nozzle 4 and a driving means arranged backward of the injection valve body 2. The injection valve body 2 includes a valve body 20 that includes in its central portion a cylinder 21, a high pressure fuel flow path 22 parallel with the cylinder 21, and a low pressure fuel flow path 23. The injection nozzle 4 is provided with a concentric needle cylinder 45 communicating with the high pressure fuel flow path 22 and the low pressure fuel flow path 23, a high pressure fuel hole 46A, and a low pressure fuel hole 47A. The injection nozzle 4 is coaxially fastened to the valve body 20 by a retaining nut, and the back end surface 4A of the injection nozzle 4 and the tip end surface 2A of the valve body 20 are caused to tightly contact each other to form a metal seal structure. Furthermore, a featured structure is adopted in the fuel injection valve 1: namely, at least an area surrounding a contact portion between the high pressure fuel flow path 22 and the high pressure fuel hole 46A forms a high pressure seal surface, and outside recesses 6A are provided outside of a metal seal surface surrounding a linkage portion between the high pressure fuel flow path 22 and the high pressure fuel hole 46A for increasing surface pressure of the high pressure seal surface.

Under this structure, the recess 6A is provided outside of an area surrounding the high pressure fuel hole 46A. A seal area in proximity of the high pressure fuel hole 46A is thereby decreased, which causes a surface pressure to increase. Furthermore, a surface pressure distribution in the direction of the leakage towards the outside is increased more than that in the central portion, so that the leakage towards the outside can be prevented.

### Embodiment 2

### Structure of Embodiment 2

FIG. 3 shows a metal seal structure in the back end surface 4A of Embodiment 2 of the present invention. Embodiment 2 is different from Embodiment 1 in that an outside recess 6A is provided so that counterboring is applied up to a position where an extended line from the center of the needle cylinder 45 to the high pressure hole 46A intersects with the outer-most peripheral border. Therefore, only proximity of the high pressure fuel hole 46A becomes a seal surface, whereas other than the proximity of the high pressure fuel hole 46A becomes a recess communicating with the outer peripheral portion.

Under this structure, the seal surface includes a seal surface portion of a proximity portion centering on the high pressure fuel hole 46A and a seal surface portion centering on the low pressure hole 47A and having almost half of the outer peripheral border. This seal surface can thereby function as sealing using a much smaller area. In particular, the proximity of the high pressure fuel hole 46A has a pressure receiving area nearly minimum, and a recess open to the outer peripheral is provided outside of the proximity. Therefore, the axial force mainly changes to a remarkable surface pressure at the proximity of the high pressure fuel hole 46A. This exhibits an excellent seal property.

### Effect of Embodiment 2

The fuel injection valve 1 of Embodiment 2 adopts a structure where an outside recess 6A is provided near an outer peripheral border is located along an extended line from the central axis of the needle cylinder 45 to the high pressure hole 46A.

Under this structure, a seal surface pressure near the high pressure fuel hole 46 can be almost designed using a seal surface area near the high pressure fuel hole 46A. Designing the minimum seal area meeting the fastening axial force secures a necessary and sufficient surface pressure and also simply and effectively enhances the seal property. This can prevent leakage to the outside.

### Embodiment 3

### Structure of Embodiment 3

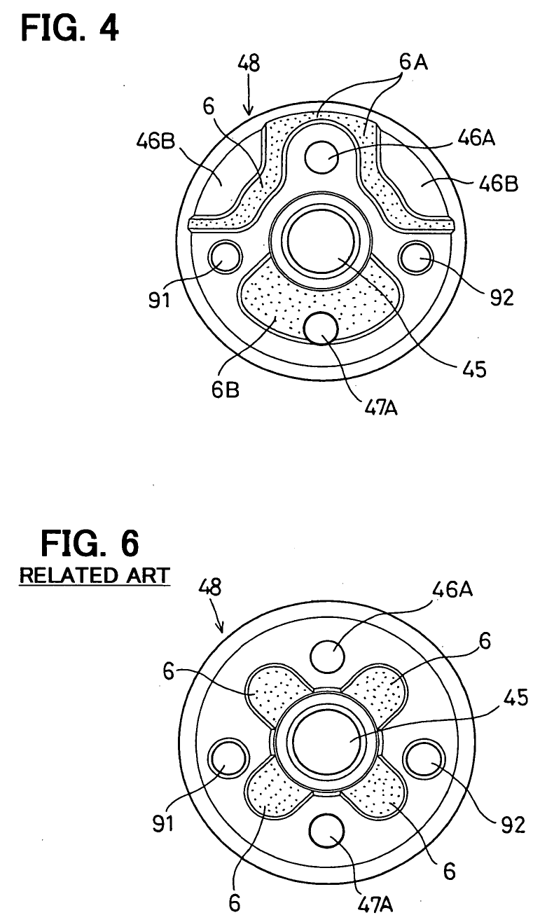

FIG. 4 shows a metal seal structure in the back end surface 4A of Embodiment 3. Retaining seal surfaces 46B are provided in the recess 6A of Embodiment 2 that is formed by being counterbored except the proximity of the high pressure fuel hole 46A. The retaining seal surfaces 46B have quarter sector forms being as high as the outer peripheral border to be symmetric with respect to the high pressure hole 46A and apart from the proximity of the high pressure fuel hole 46A by leaving part of the recess 6A of Embodiment 2.

This structure causes the proximity of the high pressure fuel hole 46A and the retaining seal surfaces 46B attached to the outer peripheral border to become even metal seal surfaces, forming a seal surface that evenly receives the axial force.

In this structure, the surface pressure is slightly decreased due to area increase of the retaining seal surfaces 46B in addition to the seal surface of the proximity of the high pressure fuel hole 46A, but the surface pressure of the proximity of the high pressure fuel hole 46A can be sufficiently secured by keeping a proper area. The object of this structure is to obtain an effect that deformation or microscopic displacement of the seal surface can be prevented from occurring and to enhance the seal property. Namely, formation of the retaining seal surfaces 46B attached to the outer peripheral border increases supporting points to three or more. Three or more supporting points make the supporting more stable than that of a case where only the proximity of the high pressure fuel hole 46A is only one supporting point. The contact can be thereby very endurable. Furthermore, no occurrence of the deformation or the displacement enables the seal area of the proximity of the high pressure fuel hole 46A to be a minimum, which can achieve a secured and effective seal.

### Effect of Embodiment 3

The fuel injection valve 1 of Embodiment 3 adopts a featured structure where contact surfaces are provided to be apart from the contact surface at the proximity of the high pressure fuel hole 46A. In this structure, the contact portion functions as not only a seal surface but also a retaining surface, thereby securing high rigidity to deformation or displacement and high seal property. Furthermore, if strong seal to the deformation or the displacement is obtained, the seal area of the contact portion of the proximity of the high pressure fuel hole 46A can be extremely minimized. This enables even only the seal surface of the surrounding of the high pressure fuel hole 46A to freely and simply secure highly sealing property, thereby preventing the leakage to the outside.

### Effect of Embodiments 1 to 3

As explained above, forming seal surfaces shown in Embodiments 1 to 3 enables a seal property to be easily secured without extremely increasing an axial force. Even when the axial force is increased, the seal property is prevented from being degraded due to deformation or the like and the increased axial force properly responds to surface pressure increase in a key point to thereby simply and also effectively secure a proper seal property.

### Other Embodiment

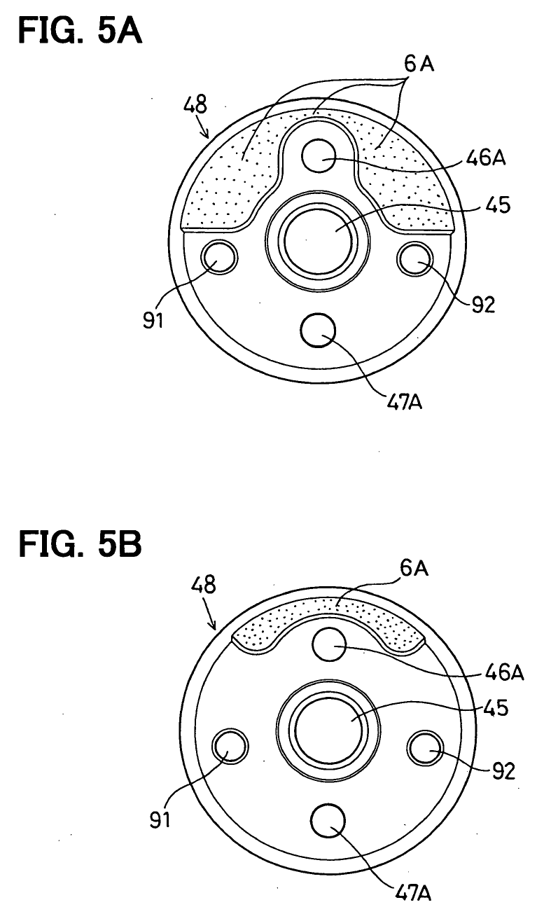

FIG. 5A shows another Embodiment. A metal seal structure includes the high pressure fuel hole 46A, the low pressure fuel hole 47A, the positioning hole 91, and the positioning pin 92 in four directions with approximately equal interval distances therebetween. In this metal seal structure, a recess 6A is provided to be bi-laterally symmetric while sandwiching the high pressure fuel hole 46A without including the proximity of the high pressure fuel hole 46A, to communicate with the outer peripheral border, to have a proper central angle, to have quarter section forms so that the proximity of the high pressure fuel hole 46A protrudes towards the outer peripheral border, and to be counterbored to leave a seal surface in an interval area with the needle cylinder 45.

In contrast, near the low fuel pressure hole 47A, no recess is provided and a seal surface is formed to be flat and even up to the outer peripheral border. As a result, the proximity of the high pressure fuel hole 46A forms an independent seal surface. A surface pressure based on the axial force can be increased locally, and high seal property can be secured.

As another Embodiment, as shown in FIG. 5B, a recess 6A is provided with the following: only counterboring that draws an circular ark and links with an outer peripheral border is processed so that the high pressure fuel hole 46A alone independently forms a seal surface. Furthermore, even though a flat seal surface remains near the low pressure fuel hole 47A, the independent seat surface in the proximity of the high pressure fuel hole 46A easily maintains the high surface pressure and thereby secures the seal property.

Thus, a possibly small area of the proximity of the high pressure fuel hole 46A is left as a seal surface and the recess is provided outside of the high pressure fuel hole 46A to link with the outer peripheral border. Therefore, since the proximity of the high pressure fuel hole 46A independently supports the high surface pressure as the seal surface, it is featured that securing the seal property of the high pressure fuel can be almost achieved in the relevant point.

(Modification)

In the above-described embodiments, a recess 6A, 6B is provided in a surface (back end surface 4A) of the injection nozzle 4. However, a recess 6A, 6B can be alternatively provided in a surface (tip end surface 2A) of the valve body 20, as long as either of the surfaces has a recess 6A, 6B and a metal seal formed by mutually contacting each other is provided.

Furthermore, the recess 6A, 6B is formed to be slightly concaved to decrease a contact area and is processed by counterboring. However, without limiting to the mechanical processing, any other method, for instance, chemical etching can be alternatively adopted as long as a recess can be formed to be slightly concaved easily and without having a strain.

Furthermore, a positioning hole and a positioning pin are provided as a pair and can be formed in either of the injection nozzle 4 and the valve body 20. If another fool-proofing method prevents mis-assembling of connecting the injection nozzle 4 and the valve body 20, the positioning pin can be replaced or dispensed with.

In the above embodiments, the driving source adopts an electromagnetic solenoid 30; however, another driving source, e.g., a piezoelectric driving source, can be adopted. Namely, any one that causes the movable element 5 to move to an end portion according to an electric input signal, especially being reliable and endurable, can be preferably adopted.

It will be obvious to those skilled in the art that various changes may be made in the above-described embodiments of the present invention. However, the scope of the present invention should be determined by the following claims.

What is claimed is:

1. An injector comprising:
an injection valve main body whose tip end is linked with an injection nozzle; and
a driving means arranged backward of the injection valve main body,
wherein the injection valve main body includes a valve body,
wherein the valve body includes in its central portion a cylinder, and further includes a high pressure fuel flow path and a low pressure fuel flow path, both of which are parallel with the cylinder,
wherein the injection nozzle is linked with the valve body and includes a needle valve linked with the cylinder, a high pressure fuel hole linked with the high pressure fuel flow path, and a low pressure fuel hole linked with the low pressure fuel flow path,
wherein a back end surface of the injection nozzle and a tip end surface of the valve body contact each other with pressure to form a metal seal structure to achieve a metal seal,
wherein a recess is provided in the metal seal structure to increase a seal surface pressure, and
an outside recess is provided outside of a metal seal in surrounding of a linkage portion between the high pressure fuel flow path and the high pressure fuel.

2. The injector of claim 1,
wherein the outside recess links with an outer peripheral border of the metal seal structure.

3. The injector of claim 2,
wherein a contact surface is provided outside of the outside recess to be apart from a contact surface being the metal seal in the surrounding of the high pressure fuel hole.
